(19) United States
(12) Patent Application Publication
(10) Pub. No.: US 2015/0168650 A1
(43) Pub. Date: Jun. 18, 2015

(54) THIN FILM FILTER (TFF) EMBEDDED WAVEGUIDE WDM DEVICE EMPLOYING PARABOLA-SHAPED WAVEGUIDES

(71) Applicant: SIPHX CORPORATION, Ibaraki (JP)

(72) Inventor: Katsunari Okamoto, Ibaraki (JP)

(73) Assignee: SIPHX CORPORATION, Ibaraki (JP)

(21) Appl. No.: 14/407,191

(22) PCT Filed: Jun. 13, 2013
(86) PCT No.: PCT/US2013/045572

§ 371 Date: Dec. 11, 2014

Related U.S. Application Data
(60) Provisional application No. 61/659,071, filed on Jun. 13, 2012.

(51) Int. Cl. G02B 6/293

(52) U.S. Cl. CPC G02B 6/2938; G02B 6/29389

(57) ABSTRACT

A wavelength-division lightwave multiplexing device, and method of its manufacture, having an embedded filter and two parabola-shaped crossing waveguides, the waveguides providing collimation of light transmitted therein. At least one of the parabola-shaped wave crossing waveguides includes a first port, and a second port, and a widened portion between the first and second ports having a parabola-shaped profile, wherein the widened portion widens from the first port toward a midpoint thereof, and then narrows to the second port. The invention achieves low insertion loss and high spectral isolation while keeping a narrow guard band smaller, and addresses the problem of poor spectral isolation characteristics in the filter-embedded waveguide WDM device when it is adopted to applications requiring a guard band narrower.

### RELATED APPLICATION INFORMATION

This application claims priority to U.S. Provisional Patent Application entitled “Thin Film Filter (TFF) Embedded Waveguide WDM Device Employing Parabola-Shaped Waveguides, filed Jun. 13, 2012, and assigned Ser. No. 61/659,071, which is hereby incorporated herein by reference in its entirety.

### TECHNICAL FIELD

The present invention relates to a waveguide WDM (wavelength division multiplexing) device to separate two or more wavelength bands. More particularly, the present invention relates to a novel filter-embedded waveguide WDM device employing parabola-shaped waveguides in the crossing region.

### BACKGROUND OF THE INVENTION

A WDM passive optical network (WDM-PON) system is believed to be the ultimate optical access network. However, time-division-multiplexing passive optical networks (TDM-PON) have already been widely deployed because of their cost-effectiveness. The guaranteed bandwidth and quality of service provided by TDM-PONs might not be enough to satisfy the increasing bandwidth requirements of future video-centric services with high-definition TV quality. Thus, current TDM-PON will eventually need to be upgraded to WDM-PON. To add WDM-PON wavelength channels while maintaining the existing fiber, optical power splitter, and wavelength plan of the current TDM-PONs, arrayed-waveguide gratings (AWGs) and wavelength band-pass filters (BPFs) should be inserted at the optical line terminal (OLT), remote node (RN), and optical network unit (ONU) as shown in FIG. 1. FIG. 2 shows wavelength allocation in the coexisting-type TDM/WDM-PON systems. The edge-filter (EF) in FIG. 2 reflects the wavelength band shorter than 1.39 μm and transmits the wavelength band longer than 1.41 μm. EF has already been used in the existing TDM-PON systems. BPF reflects 1.53-1.61 μm wavelength band and transmits 1.26-1.5 μm and 1.64-1.66 μm wavelength bands, respectively. A two-band athermal AWG (aAWG), which is added in the remote node, deals with downstream (C-band) and upstream (L-band) signals.

Though bulk-type BPFs have generally been used for wavelength filtering applications, cost-effective and compact band-pass filters are strongly required. Bulk-type filters pose certain problems for cost reduction in mass production and the realization of the compact array modules required for remote nodes. BPFs using a TFF embedded silica-based planar lightwave circuit (PLC) [Y. Inoue, et al., “Filter embedded wavelength-division multiplexer for hybrid-integrated transceiver based on silica-based PLC,” Electron. Lett., vol. 32, no. 9, pp. 847-848, 1996] are very attractive due to their compactness, mass productivity and high reliability.

What is needed is a simple and efficient evolution path from TDM-PON to WDM-PON without a change in the current TDM-PON infrastructure. It is also highly desired to maintain the previously established wavelength plan of existing TDM-PON.

### SUMMARY OF THE INVENTION

The shortcomings of the prior art are overcome and additional advantages are provided by the present invention which in one aspect is a wavelength-division lightwave multiplexing device, and method of its manufacture, having an embedded filter and two parabola-shaped crossing waveguides, the waveguides providing collimation of light transmitted therein. At least one of the parabola-shaped wave crossing waveguides includes a first port, and a second port, and a widened portion between the first and second ports having a parabola-shaped profile, wherein the widened portion widens from the first port toward a midpoint thereof, and then narrows to the second port.

The present invention is capable of achieving low insertion loss and high spectral isolation while keeping a narrow guard band smaller than 0.03 μm (30 nm), using, e.g., a novel crossing waveguide configuration employing parabola-shaped waveguides.

The present invention addresses the problem of poor spectral isolation characteristics in a filter-embedded waveguide WDM device when it is adopted to applications requiring a guard band narrower than 0.03 μm (30 nm).

Further, additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in connection with the accompanying drawings in which:

FIG. 1 depicts a coexistence-type TDM/WDM-PON system architecture;

FIG. 2 depicts the wavelength allocation of a coexistence-type TDM/WDM-PON network;

FIG. 3 depicts TFF embedded crossing waveguides with linearly tapered and broadened waveguides;

FIG. 4 depicts transmittance T and loss L of the TFF embedded crossing waveguides in FIG. 3 from port C to port A measured for p- and s-polarizations (Θ=8 degree);

FIGS. 5(a)-(d) depict a simulation of the light beam propagation in the TFF embedded crossing waveguides with Θ=8 degree from port C to port A (TFFs are not shown), where FIG. 5(a) shows the broad waveguides, FIG. 5(b) shows light beam propagation (with vertical axes compressed for display purpose), FIG. 5(c) is an enlarged view of the crossing waveguides of FIG. 5(a), and FIG. 5(d) is an enlarged view of the light beam propagation of FIG. 5(b);

FIG. 6 depicts TFF embedded crossing waveguides employing a curved, e.g., parabola-shaped waveguide;

FIG. 7 depicts a simulation of the light beam propagation in the TFF embedded parabola crossing waveguide; and

FIG. 8 shows transmittance T and loss L of the TFF embedded crossing waveguides of FIG. 6 from port C to port A measured for p- and s-polarizations (Θ=8 degree).

### DETAILED DESCRIPTION OF THE INVENTION

Presently, the problems discussed above may be solved by, for example, using a linearly tapered waveguide to expand the mode-field of the incident light to the TFF in order to suppress the diffraction of the incident light in the groove [M. Yanagisawa, et al., “Low-loss and compact TFF-embedded silica-waveguide WDM filter for video distribution services in FTTH systems,” Optical Fiber Communication Conference, February 22-26, TuI4, pp. 847-848, 2004].

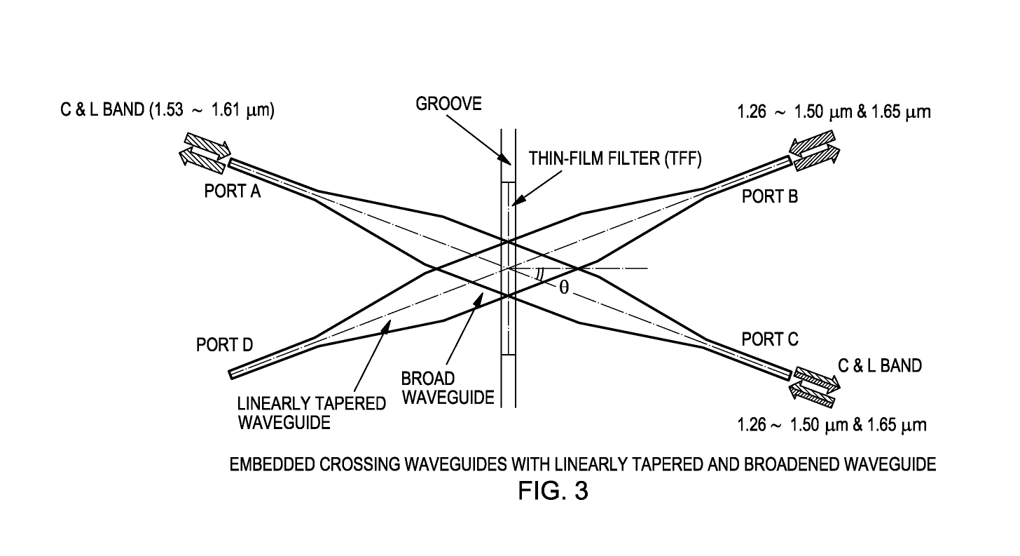

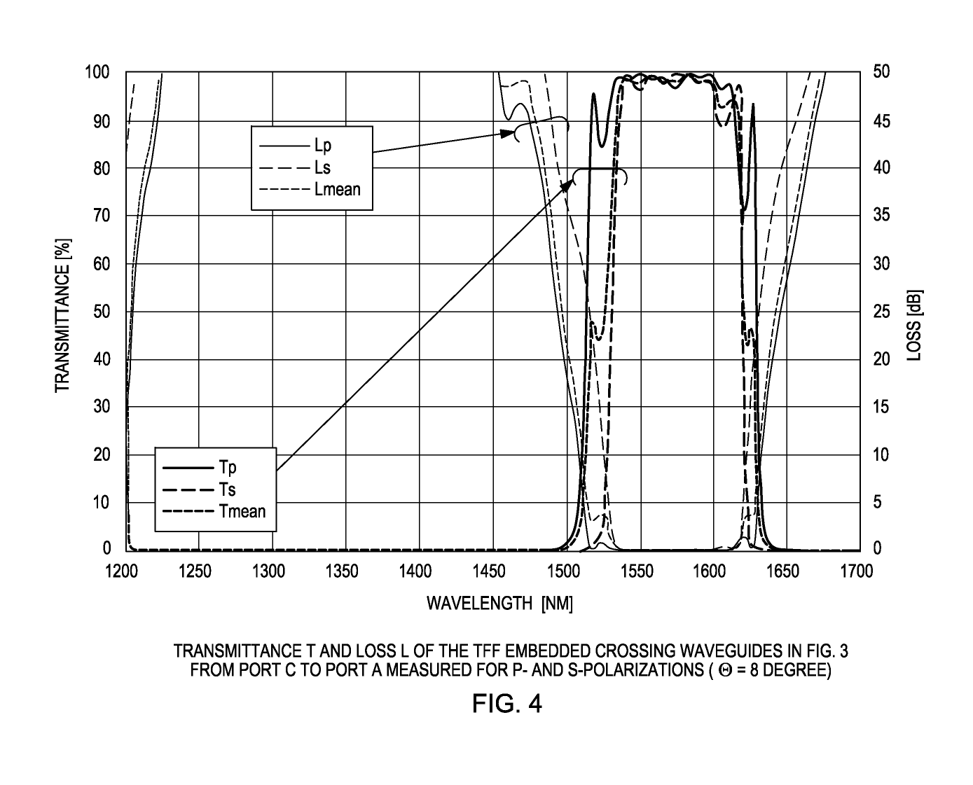

FIG. 3 shows the schematic configuration of TFF embedded crossing waveguides with linear taper and broadened waveguide. A TFF which is composed of a dielectric multilayer evaporated on a polyimide substrate [T. Oguchi, et al., “Dielectric multilayered interference filters deposited on polyimide films,” Electron. Lett., vol. 27, pp. 706-707, 1991] is inserted into a groove formed at a cross-waveguide intersection. θ is an incident angle of the incoming light to the TFF. The incident angle is normally θ=4˜8 degree in order to achieve high spectral isolation characteristics. The intersecting angle of the two waveguides is defined by Θ=20.

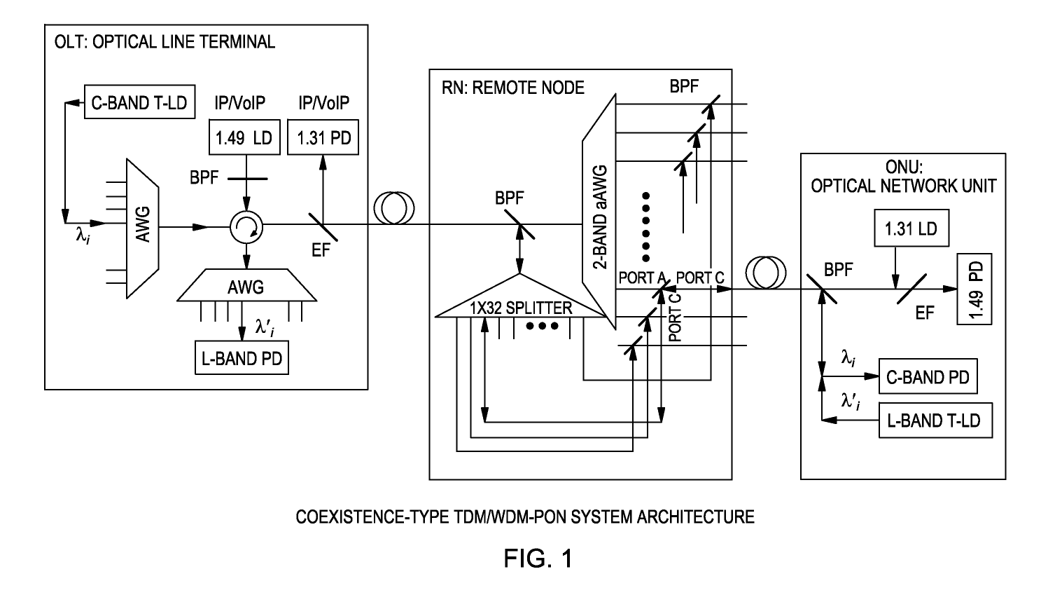

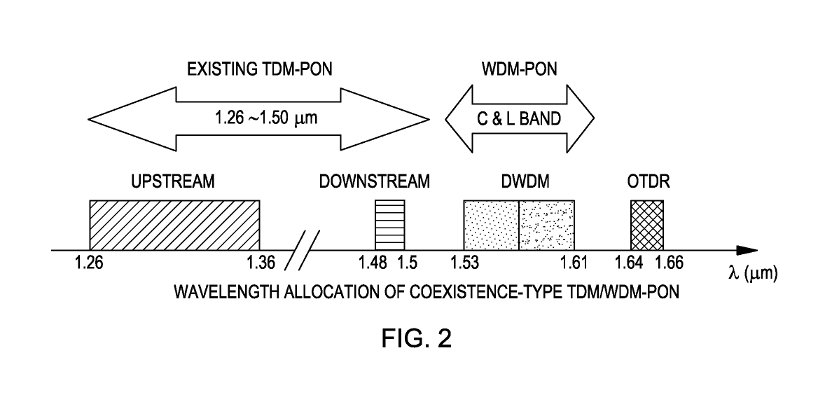

The TFF is designed to have a passband at 1.53-1.61 μm and a reflection band at 1.26-1.50 μm and 1.64-1.66 μm. As shown in FIG. 1, port A is connected to the output of a two-band aAWG, port B is connected to the output of splitter, and port C is connected to the subscriber-side optical fiber, respectively.

A linear taper is adopted to expand the mode-field of the incident light to the TFF to suppress the diffraction of the incident light in the groove region. A 30 μm-thick dielectric multilayered TFF is inserted into the 35 μm-thick groove and fixed with adhesive.

The silica-based crossing waveguides may be fabricated on a Si substrate by a combination PECVD (plasma-enhanced chemical vapor deposition) and reactive ion etching. The refractive-index difference is Δ=0.3%, thickness of the core is 7 μm, and the width of the core is 7 μm, respectively. Core width in the crossing region may be expanded to 20 μm by the 1000-μm linear taper.

FIG. 4 shows experimental transmittance T (Tp, Ts, and Tₘₑₐₙ) and loss L (Lp, Ls, and Lₘₑₐₙ) of the TFF embedded crossing waveguides in FIG. 3 from port C to port A measured for p- and s-polarizations, respectively. Tₘₑₐₙ and Lₘₑₐₙ are transmittance and loss measured by using un-polarized beam.

Insertion loss from port C to port A (Lₘₑₐₙ in the 1.53-1.61 μm region in FIG. 4) is about 0.8˜1.4 dB and reflection loss from port C to port B (Tₘₑₐₙ in the 1.26-1.50 μm and 1.64-1.66 μm regions in FIG. 4) is about 0.5˜1.0 dB. These reasonably low losses are obtained by using a broadened waveguide. However, it is known from FIG. 4 that filter characteristic is strongly dependent on the input polarization state and guard band is much wider than 0.03 μm (30 nm). Here guard band is the spectral separation at 1.515 μm and 1.625 μm in FIG. 4.

When the guard band is not narrow, two band groups (for example, 1.26-1.50 μm band and 1.53-1.61 μm band) cannot be packed closely. Then, the wide guard band leads to inefficient bandwidth utilization in WDM systems.

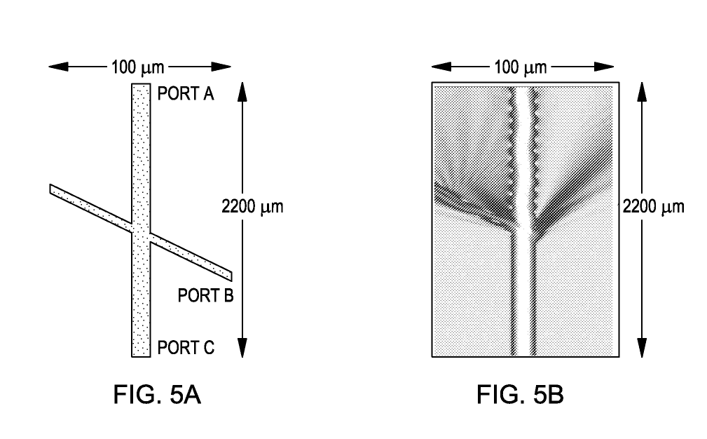

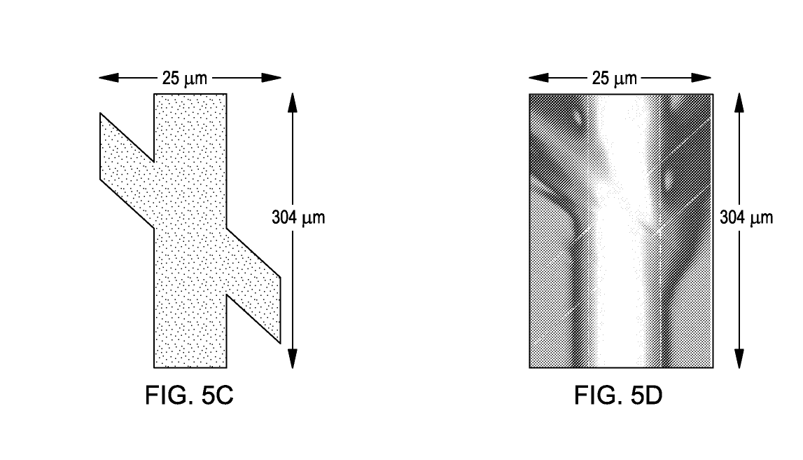

The reason why TFF embedded crossing waveguides with linearly tapered and broadened waveguides in FIG. 3 cannot achieve narrow guard band high spectral isolation characteristics is explained by a numerical simulation. FIGS. 5(a)-(d) show simulation of the light beam propagation at λ=1.49 μm in the TFF embedded crossing waveguides in FIG. 3 from port C to port A (TFFs are not shown). FIG. 5(a) shows crossing broad waveguides and FIG. 5(b) shows the amplitude of the light beam propagation. It is noted here that vertical axes are very much compressed for display purposes. It is known from FIG. 5(b) that part of the incoming light leaks out into port D. It causes insertion loss increase for the through port from C to A. Poor spectral isolation characteristics and rather wide guard band can be explained by FIGS. 5(c) and (d) which are enlarged views of FIGS. 5(a) and (b), respectively. It is known from FIG. 5(d) that light propagation direction is largely deflected in the crossing waveguide region. A TFF that is inserted in the crossing region does not cause light beam deflection because the refractive index of the TFF is matched with that of the core. Light beam deflection is caused by the fact that incoming light is not collimated and thus it is pulled by the presence of the other crossing waveguide from port B. When the deflected light enters into the TFF, incident angle becomes different from the ideal angle. Then, light propagation direction to through port A and reflection port B become different from those in the ideal conditions. Therefore, it is shown that collimating the incoming light is quite important in order to achieve good spectral isolation characteristics and a narrow guard band.

The present invention provides a collimated light beam that is required to achieve good spectral isolation characteristics and a narrow guard band in the TFF-embedded waveguide WDM device.

This new waveguide technology for the TFF-embedded WDM filter is designed to achieve low insertion loss and high spectral isolation while keeping a narrow guard band.

In this invention, parabola-shaped waveguides are used in the crossing waveguides to achieve light beam collimation. A parabola-shaped waveguide itself is known to be able to collimate the light beam [W. K. Burns, A. F. Milton, and A. B. Lee, “Optical waveguide parabolic coupling horns,” Appl. Phys. Lett., vol. 30, pp. 28-30, 1977].

However, parabola-shaped waveguides have never been used in the TFF-embedded WDM filter devices where a very small intersecting angle (Θ=8˜16 degree) is required to achieve high spectral isolation characteristics.

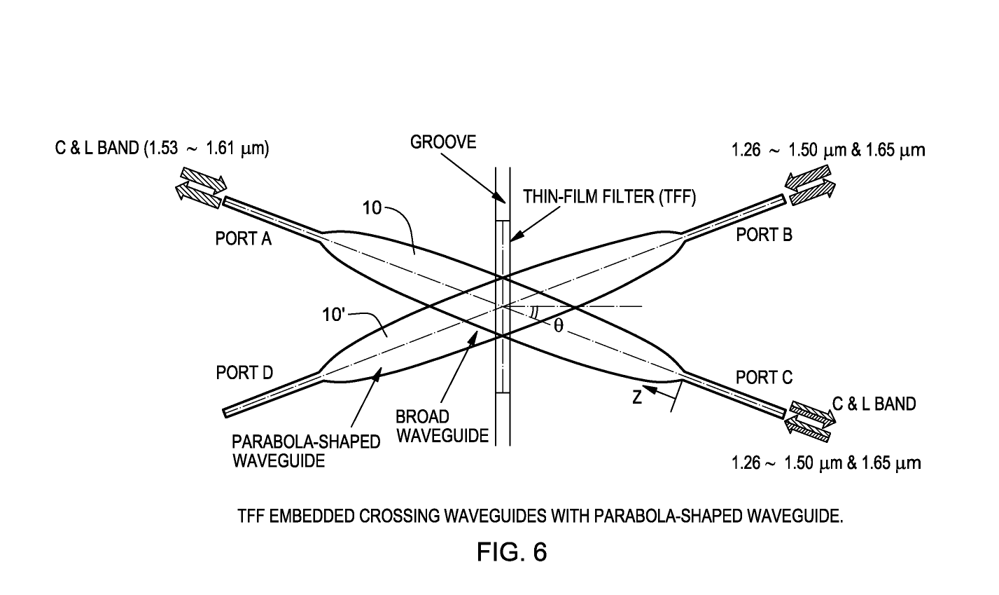

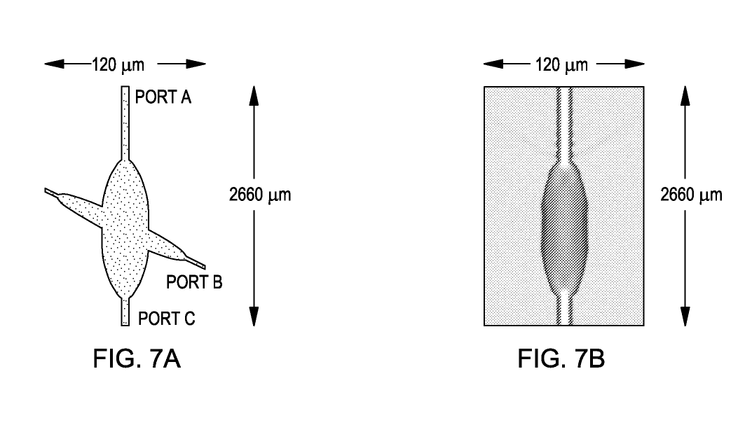

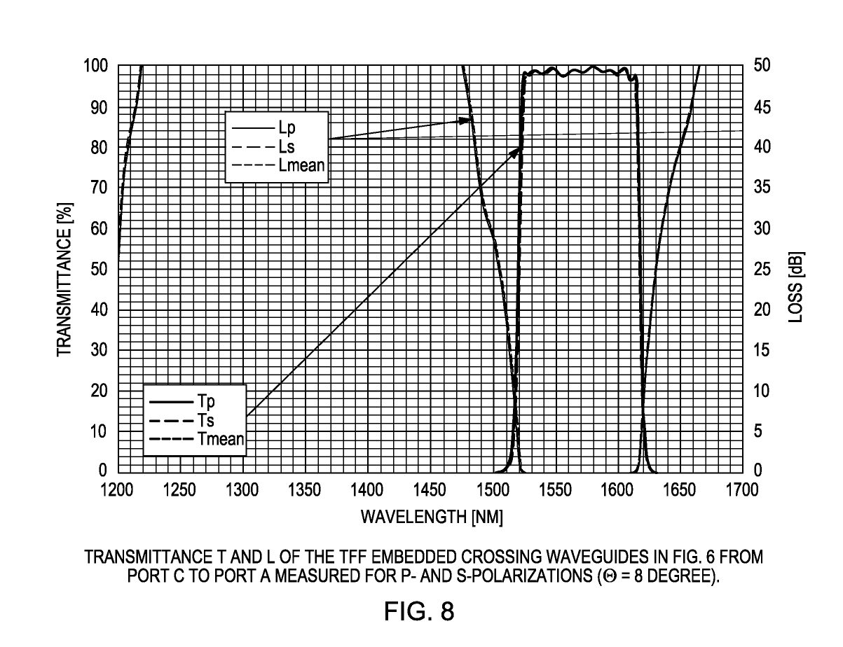

FIG. 6 shows TFF embedded crossing waveguides using curved waveguides 10 and 10′ (such as parabola-shaped waveguides) as a beam collimator. In this example, core width is expanded from Dia=7 μm to about 35 μm by the parabola-shaped waveguide and then the broad waveguide with 35 μm width crosses each other. The core width in the parabola-shaped waveguide is expressed by:

W(z)=\sqrt{αz+Dᵢₐ²}(z=0˜Zₘₐₓ), (1)

where z is measured along the light propagation direction from the interface between normal core and parabola waveguide (z=0). Parameter α indicates the growing factor of the parabola. α=2.5 and Zₘₐₓ=470 μm in the exemplary design of FIG. 6. Parameters α and Zₘₐₓ can be varied depending on the refractive-index of the core A and intersecting angle Θ.

FIGS. 7(a)-(b) show a simulation of the light beam propagation at λ=1.49 μm in the TFF embedded waveguide crossing with parabola-shaped waveguides of FIG. 6 from port C to port A (TFFs are not shown). FIG. 7(a) shows crossing parabola waveguides and (b) is amplitude light beam propagation.

It is clearly shown in FIG. 7(b) that propagating light beam from port C to A is not affected by the presence of the other crossing waveguide. The insertion loss increase can be suppressed by the well collimated beam propagation. Also, good spectral isolation and narrow guard band are achievable because the incident angle θ is kept for transmitting and reflecting light beam as it is designed.

FIG. 8 is the experimental transmittance T and loss L of the TFF embedded waveguide crossing with parabola-shaped waveguides of FIG. 6 from port C to port A measured for p- and s-polarizations (Θ=8 degree).

Insertion loss from port C to port A (Lₘₑₐₙ in the 1.53-1.61 μm region in FIG. 8) is about 0.6˜0.8 dB and reflection loss from port C to port B (Tₘₑₐₙ in the 1.26-1.50 μm and 1.64-1.66 μm regions in FIG. 8) is about 0.3˜0.5 dB. These lower losses than those in FIG. 4 are obtained by the use a parabola-shaped waveguides. The guard-band width narrower than 0.03 μm (30 nm) has been achieved at 1.515 μm and 1.625 μm in FIG. 8. These spectral isolation characteristics are comparable to those of bulk-type spectral filters. But, the TFF embedded PLC has great advantage over bulk-type filters in compactness, mass productivity and high reliability.

In summary as discussed above and depicted in the drawings, the present invention in one aspect is a wavelength-division lightwave multiplexing device, and method of its manufacture, having an embedded filter and two parabola-shaped crossing waveguides, the waveguides providing collimation of light transmitted therein. At least one of the parabola-shaped wave crossing waveguides includes a first port, and a second port, and a widened portion between the first and second ports having a parabola-shaped profile, wherein the widened portion widens from the first port toward a midpoint thereof, and then narrows to the second port. The invention achieves low insertion loss and high spectral isolation while keeping a narrow guard band smaller, and addresses the problem of poor spectral isolation characteristics in the filter-embedded waveguide WDM device when it is adopted to applications requiring a guard band narrower.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

1. A wavelength-division lightwave multiplexing device, comprising an embedded filter and two parabola-shaped crossing waveguides, the waveguides providing collimation of light transmitted therein.

2. The wavelength-division lightwave multiplexing device of claim 1, wherein at least one of the parabola-shaped wave crossing waveguides includes a first port, and a second port, and a widened portion between the first and second ports having a parabola-shaped profile.

3. The wavelength-division lightwave multiplexing device of claim 2, wherein the widened portion widens from the first port toward a midpoint thereof, and then narrows to the second port.

4. The wavelength-division lightwave multiplexing device of claim 3, wherein the widened portion widens from about 7 μm at the first port to about 35 μm at the midpoint thereof, and then narrows back to about 7 μm at the second port.

5. The wavelength-division lightwave multiplexing device of claim 1, wherein insertion loss from the first port to the second port in the 1.53-1.61 μm region is about 0.6˜0.8 dB.

6. The wavelength-division lightwave multiplexing device of claim 1, having a guard-band width narrower than 0.03 μm.

7. The wavelength-division lightwave multiplexing device of claim 6, wherein the guard band corresponds to transmitted wavelengths of about 1.515 μm and 1.625 μm.

8. The wavelength-division lightwave multiplexing device of claim 1, wherein an angle of intersection of axes of the waveguides is about 8 degrees.

9. A method of forming a wavelength-division lightwave multiplexing device, including forming an embedded filter and two parabola-shaped crossing waveguides, the waveguides providing collimation of light transmitted therein.

10. The method of claim 9, wherein at least one of the parabola-shaped wave crossing waveguides includes a first port, and a second port, and a widened portion between the first and second ports having a parabola-shaped profile.

11. The method of claim 10, wherein the widened portion widens from the first port toward a midpoint thereof, and then narrows to the second port.

12. The method of claim 11, wherein the widened portion widens from about 7 μm at the first port to about 35 μm at the midpoint thereof, and then narrows back to about 7 μm at the second port.

13. The method of claim 9, wherein insertion loss from the first port to the second port in the 1.53-1.61 μm region is about 0.60.8 dB.

14. The method of claim 9, having a guard-band width narrower than 0.03 μm.

15. The method of claim 14, wherein the guard band corresponds to transmitted wavelengths of about 1.515 μm and 1.625 μm.

16. The method of claim 9, wherein an angle of intersection of axes of the waveguides is about 8 degrees.
